(19) United States
(12) Patent Application Publication
(10) Pub. No.: US 2026/0135805 A1
(43) Pub. Date: May 14, 2026

(54) DATA TRANSMISSION METHOD AND APPARATUS, DEVICE, AND STORAGE MEDIUM

(71) Applicant: Tencent Technology (Shenzhen) Company Limited, Shenzhen (CN)

(72) Inventor: Yong YANG, Shenzhen (CN)

(21) Appl. No.: 19/440,337

(22) Filed: Jan. 5, 2026

Related U.S. Application Data
(63) Continuation of application No. PCT/CN2024/109761, filed on Aug. 5, 2024.

(30) Foreign Application Priority Data
Oct. 9, 2023 (CN) 202311301444.4

(51) Int. Cl. H04L 45/745; H04W 60/04

(52) U.S. Cl. CPC H04L 45/745; H04W 60/04

(57) ABSTRACT

This application provides a data transmission method performed by a computer device acting as a core network device of a network including a first terminal and a second terminal, and relates to the field of communication technologies. The method includes: receiving a data packet sent by the first terminal; obtaining a destination address of the data packet; and when the destination address is an address of a specified-type terminal stored in a core network device, sending the data packet to the second terminal through a downlink channel between the core network device and the second terminal corresponding to the destination address. The foregoing solution shortens a data packet transmission path between terminals, and improves efficiency, security, and stability of data transmission.

### CROSS-REFERENCE TO RELATED APPLICATIONS

This application is a continuation application of PCT Patent Application No. PCT/CN2024/109761, entitled “DATA TRANSMISSION METHOD AND APPARATUS, DEVICE, AND STORAGE MEDIUM” filed on Aug. 5, 2024, which claims priority to Chinese Patent Application No. 2023113014444, entitled “DATA TRANSMISSION METHOD AND APPARATUS, DEVICE, AND STORAGE MEDIUM” filed with the China National Intellectual Property Administration on Oct. 9, 2023, all of which are incorporated herein by reference in their entirety.

### FIELD OF THE TECHNOLOGY

Embodiments of this application relate to the field of communication technologies, and in particular, to a data transmission technology.

### BACKGROUND OF THE DISCLOSURE

With continuous development of communication technologies, application of a private 5G network is becoming wider.

In a related technology, when data is transmitted between two terminals in the private 5G network, a terminal on a sending side needs to send the data to an application server through a core network of the private 5G network, and the application server forwards the data to a terminal on a receiving side through a 5G core network.

In the foregoing solution, a data transmission path between the two terminals is long, affecting efficiency, security, and stability of data transmission.

### SUMMARY

Embodiments of this application provide a data transmission method and apparatus, a device, and a storage medium, to shorten a data transmission path between terminals and improve efficiency, security, and stability of data transmission. The technical solutions are as follows.

According to an aspect, a data transmission method is performed by a computer device acting as a core network device of a network including a first terminal and a second terminal. The method includes:
receiving a data packet sent by the first terminal;
obtaining a destination address of the data packet; and
when the destination address is an address of a specified-type terminal stored in the core network device, sending the data packet to the second terminal through a downlink channel between the core network device and the second terminal corresponding to the destination address.

According to an aspect, a data transmission method is provided, and performed by a first terminal. The method includes:
obtaining an address of a second terminal;
generating a data packet by using the address of the second terminal as a destination address; and
sending the data packet to a core network device, so that the core network device obtains the destination address of the data packet, and sending the data packet to the second terminal through a downlink channel between the core network device and the second terminal when the destination address is an address of a specified-type terminal stored in the core network device.

According to an aspect, a data transmission method is provided, and performed by an application server. The method includes:
receiving a registration request sent by a second terminal, the registration request being configured for requesting to register the second terminal as a specified-type terminal; and
sending an address addition request to a core network device, the address addition request including an address of the second terminal, and the address addition request being configured for indicating the core network device to store the address of the second terminal as an address of the specified-type terminal, so that after the core network device receives a data packet sent by a first terminal and obtains a destination address of the data packet, the core network device sends, when the destination address is the address of the specified-type terminal stored in the core network device, the data packet to the second terminal through a downlink channel between the core network device and the second terminal corresponding to the destination address.

According to still another aspect, a computer device is provided. The computer device includes a processor, a memory, and a transceiver. The memory has at least one computer instruction stored therein, and the at least one computer instruction is loaded and executed by the processor, to cause the computer device to act as a core network device of a network including a first terminal and a second terminal and implement the foregoing data transmission method.

According to still another aspect, a non-transitory computer-readable storage medium is provided. The storage medium has at least one computer instruction stored therein, and the at least one computer instruction is loaded and executed by a processor of a computer device, to cause the computer device to act as a core network device of a network including a first terminal and a second terminal and implement the foregoing data transmission method.

The technical solutions provided in embodiments of this application have at least the following beneficial effects.

The core network device may store the address of the specified-type terminal. When the data packet sent by the first terminal is received, and the destination address of the data packet is the address of the specified-type terminal, the data packet may be directly sent to the second terminal through the downlink channel between the core network device and the second terminal corresponding to the destination address, without being forwarded to the second terminal through the application server. In other words, data packet exchange and transmission between the core network device and the application server is omitted, compared with that in an implementation solution in the related technology, thereby shortening a data packet transmission path between the first terminal and the second terminal, and improving efficiency, security, and stability of data transmission.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an implementation environment of a solution according to an embodiment of this application.

FIG. 2 is an architectural diagram of a private 5G network according to this application.

FIG. 3 is a flowchart of a data transmission method according to an embodiment of this application.

FIG. 4 is a flowchart of a data transmission method according to an embodiment of this application.

FIG. 5 is a flowchart of a data transmission method according to an embodiment of this application.

FIG. 6 is a flowchart of a data transmission method according to an embodiment of this application.

FIG. 7 is a schematic structural diagram of a network according to this application.

FIG. 8 is a schematic diagram of an end-to-end service procedure according to this application.

FIG. 9 is a block diagram of a data transmission apparatus according to an embodiment of this application.

FIG. 10 is a block diagram of a data transmission apparatus according to an embodiment of this application.

FIG. 11 is a block diagram of a data transmission apparatus according to an embodiment of this application.

FIG. 12 is a structural block diagram of a computer device according to an exemplary embodiment of this application.

### DESCRIPTION OF EMBODIMENTS

To make objectives, technical solutions, and advantages of this application clearer, implementations of this application are further described in detail below with reference to the drawings.

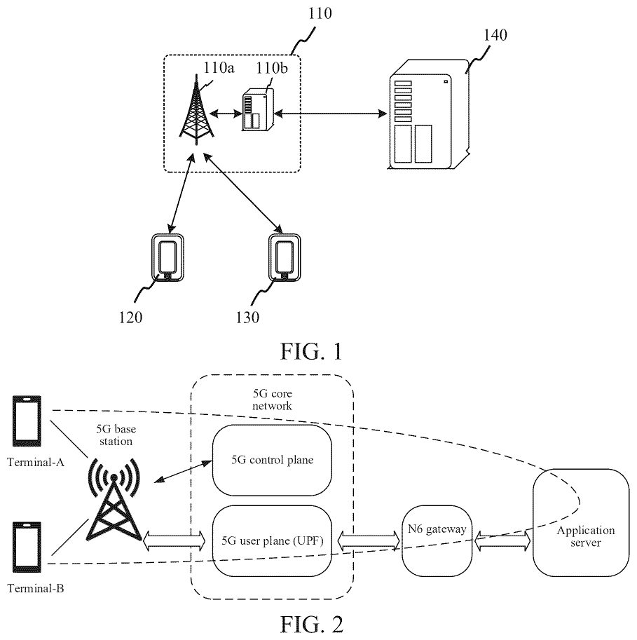

FIG. 1 is a schematic diagram of a communication system according to an exemplary embodiment of this application. The communication system includes a network device 110, a terminal device 120, a terminal device 130, and an application server 140. A quantity of terminal devices is not limited in this application.

The network device 110 in this application provides access and management functions for wireless communication. The network device 110 may include an access network device 110a and a core network device 110b. The access network device 110a may have various possible implementation forms, such as a base station, an access node, a radio network controller, a base station controller, a base transceiver station, or a baseband unit, may be a next-generation NodeB (gNB) or a transmission point in a 5th generation (5G) mobile communication system, may be one or a group of antenna panels (including a plurality of antenna panels) of a base station in a 5G system, or may be a network node forming a gNB or a transmission point.

A function of the core network device 110b is mainly to provide establishment and management of user connection, management for a user, and bearer of a service, and serve as an interface to an external network. The core network device 110b may process and distribute a service in an entire network.

The terminal device 120 and/or the terminal device 130 may alternatively be referred to as a terminal, user equipment (UE), or the like. The terminal device includes, but is not limited to, a sensor device, an industrial Internet of Things device, a handheld device, a wearable device, a vehicle-mounted device, and the like, for example, a wireless terminal, a mobile phone, a tablet computer, a television, a game console, an augmented reality (AR) terminal, a virtual reality (VR) terminal, a mixed reality (MR) terminal, and customer-premises equipment in systems such as industrial control, self-driving, telemedicine, a smart grid, transportation security, a smart city, and a smart home.

The network device 110 communicates with the terminal device 120 and/or the terminal device 130 by using an air interface technology.

The network device 110 communicates with the application server 140 through a wired interface, for example, through an N6 interface.

The communication system shown in embodiments of this application may be implemented as a private network (for example, a private 5G network), or the foregoing communication system may include a private network (that is, a part of the foregoing communication system may be used as a private network).

The private 5G network is an enterprise or industry wireless private network constructed by using a 3GPP 5G standard. A 3GPP standard defines two private 5G network deployment modes: a stand-alone non-public network (SNPN) and a public network integrated non-public network (PNI-NPN). The PNI-NPN is also referred to as “public network-dedicated”, meaning that an enterprise may deploy the private 5G network by sharing a RAN of a public 5G network with an operator, or sharing a RAN and a core network control plane, or sharing a public 5G network in an end-to-end manner (through end-to-end network slicing). The SNPN is also referred to as an “independent deployment mode”, meaning an entire 5G network independently deployed by an enterprise from a base station to a core network to a cloud platform, and may be isolated from a public 5G network of an operator.

The private 5G network is applied to industrial Internet scenarios such as smart warehouse and smart logistics. In most scenarios, a quantity of user terminals is limited, and a set of 5G core network products with a minimum capacity can satisfy requirements of the application scenarios.

Refer to FIG. 2. FIG. 2 is an architectural diagram of a private 5G network according to this application. As shown in FIG. 2, in a possible solution, when a 5G terminal-A needs to send data to a 5G terminal-B, the terminal-A sends the data to an application server in a core network via a user plane function (UPF) and an N6 gateway, and then the application server sends the data in a downlink to the terminal-B through the N6 gateway and the UPF. The terminal-B returns data to the terminal-A in a same way as the foregoing procedure.

In a framework shown in FIG. 2, a data transmission path between the terminal-A and the terminal-B is long, and efficiency, security, and stability of data transmission are affected. To resolve the problem, this application provides a new data transmission solution based on the framework shown in FIG. 2. By using related functions provided by a core network device, data transmission may be directly implemented between two terminals, to shorten a data transmission path between the terminals, and improve efficiency, security, and stability of the data transmission between the terminals.

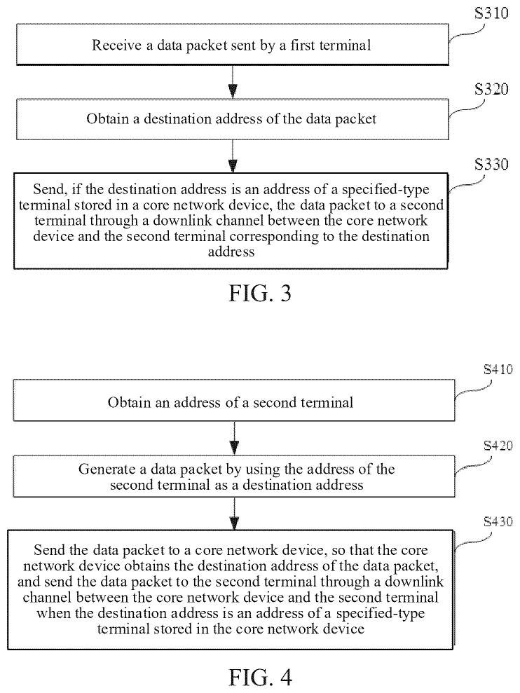

Refer to FIG. 3. FIG. 3 is a flowchart of a data transmission method according to an embodiment of this application. The method may be implemented by the core network device 110b of the system shown in FIG. 1. As shown in FIG. 3, the method may include the following operations.

Operation 310: Receive a data packet sent by a first terminal.

In this embodiment of this application, when sending the data packet to a second terminal, the first terminal may first send the data packet to a core network device through an uplink channel between the first terminal and the core network device, and the core network device receives the data packet.

Operation 320: Obtain a destination address of the data packet.

After receiving the data packet, the core network device may parse an address field of the data packet, for example, parse an address field in a packet header of the data packet, and extract the destination address therein, namely, an address of a receiving device corresponding to the data packet, in other words, an address of the second terminal.

The foregoing destination address may be an Internet protocol (IP) address.

Alternatively, the foregoing destination address may be a media access control (MAC) address.

Alternatively, the foregoing destination address may be a user-defined address. For example, the foregoing destination address may be a virtual address defined by the core network device or an application server for the second terminal.

In some embodiments, when the foregoing destination address is the MAC address, the core network device may query a corresponding MAC address through an IP address of a destination terminal (namely, the second terminal) in the data packet.

In some embodiments, when the foregoing destination address is the MAC address or the user-defined address, in addition to carrying the IP address of the destination terminal (namely, the second terminal), the data packet further needs to additionally carry the destination address. For example, a communication protocol may be improved via the communication system in this application by adding the foregoing destination address (namely, the MAC address or the user-defined address) to the address field in the packet header of the data packet, or by adding a field carrying the MAC address or the user-defined address to the packet header of the data packet, or by carrying the MAC address or the user-defined address in a reserved field in the packet header of the data packet.

Operation 330: Send, if the destination address is an address of a specified-type terminal stored in a core network device, the data packet to a second terminal through a downlink channel between the core network device and the second terminal corresponding to the destination address.

In embodiments of this application, the core network device may store an address of one or more specified-type terminals. The foregoing specified-type terminal may be a terminal that allows a data packet to be directly forwarded through the core network device without being forwarded through the application server. After obtaining the destination address of the data packet, the core network device may compare the destination address with locally stored addresses of the specified-type terminals. If the destination address is one of the locally stored addresses of the specified-type terminals, the core network device determines that the data packet is a data packet to be sent to the specified-type terminal. In this case, the data packet may be directly sent to the second terminal through the downlink channel between the core network device and the second terminal corresponding to the destination address.

In conclusion, in the solution shown in this embodiment of this application, the core network device may store the address of the specified-type terminal. When the data packet sent by the first terminal is received, and the destination address of the data packet is the address of the specified-type terminal, the data packet may be directly sent to the second terminal through the downlink channel between the core network device and the second terminal corresponding to the destination address, without being forwarded to the second terminal through the application server. In other words, data packet exchange and transmission between the core network device and the application server is omitted, compared with that in an implementation solution in the related technology, thereby shortening a data packet transmission path between the first terminal and the second terminal, and improving efficiency, security, and stability of data transmission.

Refer to FIG. 4. FIG. 4 is a flowchart of a data transmission method according to an embodiment of this application. The method may be implemented by the first terminal 120 of the system shown in FIG. 1. As shown in FIG. 4, the method may include the following operations.

Operation 410: Obtain an address of a second terminal.

Operation 420: Generate a data packet by using the address of the second terminal as a destination address.

Operation 430: Send the data packet to a core network device, so that the core network device obtains the destination address of the data packet, and send the data packet to the second terminal through a downlink channel between the core network device and the second terminal when the destination address is an address of a specified-type terminal stored in the core network device.

In conclusion, in the solution shown in this embodiment of this application, the core network device may store the address of the specified-type terminal. When sending the data packet to the second terminal, a first terminal sends the data packet to the core network device. When the core network device receives the data packet sent by the first terminal, and the destination address of the data packet is the address of the specified-type terminal, the data packet may be directly sent to the second terminal through the downlink channel between the core network device and the second terminal, without being forwarded to the second terminal through an application server. In other words, data packet exchange and transmission between the core network device and the application server is omitted, compared with that in an implementation solution in the related technology, thereby shortening a data packet transmission path between the first terminal and the second terminal, and improving efficiency, security, and stability of data transmission.

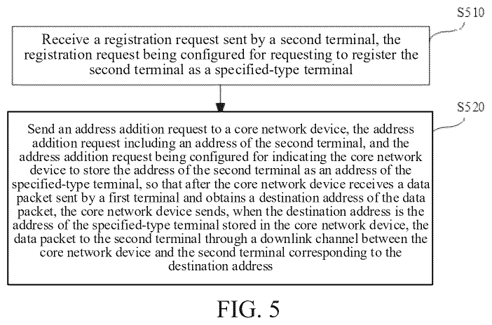

Refer to FIG. 5. FIG. 5 is a flowchart of a data transmission method according to an embodiment of this application. The method may be implemented by the application server 140 of the system shown in FIG. 1. As shown in FIG. 5, the method may include the following operations.

Operation 510: Receive a registration request sent by a second terminal, the registration request being configured for requesting to register the second terminal as a specified-type terminal.

Operation 520: Send an address addition request to a core network device, the address addition request including an address of the second terminal, and the address addition request being configured for indicating the core network device to store the address of the second terminal as an address of the specified-type terminal, so that after the core network device receives a data packet sent by a first terminal and obtains a destination address of the data packet, the core network device sends, when the destination address is the address of the specified-type terminal stored in the core network device, the data packet to the second terminal through a downlink channel between the core network device and the second terminal corresponding to the destination address.

In conclusion, in the solution shown in this embodiment of this application, registration of the second terminal with the application server as the specified-type terminal may be performed. In this process, the application server may indicate the core network device to store the address of the second terminal as the address of the specified-type terminal. When sending the data packet to the second terminal, the first terminal sends the data packet to the core network device. When the core network device receives the data packet sent by the first terminal, and the destination address of the data packet is the address of the specified-type terminal, the data packet may be directly sent to the second terminal through the downlink channel between the core network device and the second terminal corresponding to the destination address, without being forwarded to the second terminal through the application server. In other words, data packet exchange and transmission between the core network device and the application server is omitted, compared with that in an implementation solution in the related technology, thereby shortening a data packet transmission path between the first terminal and the second terminal, and improving efficiency, security, and stability of data transmission.

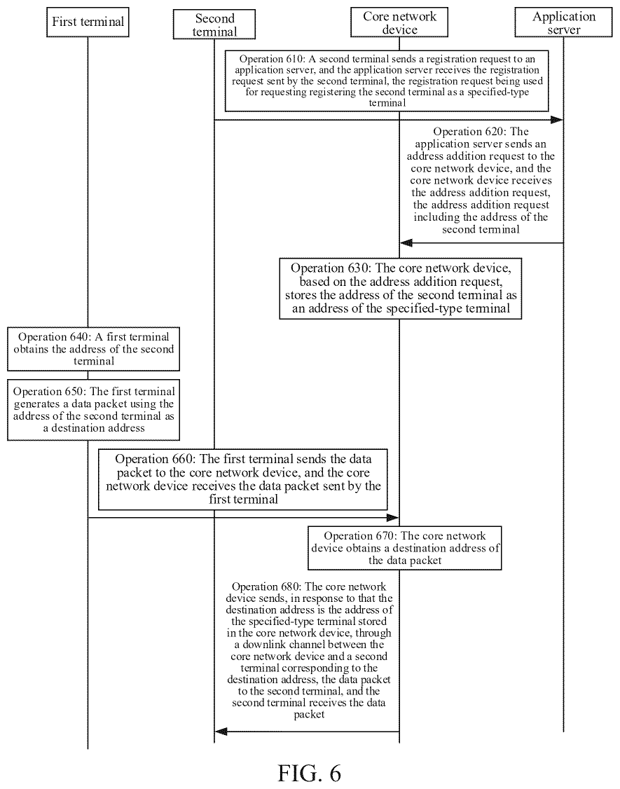

Refer to FIG. 6. FIG. 6 is a flowchart of a data transmission method according to an embodiment of this application. The method may be interactively implemented by the core network device 110b, the first terminal 120, the second terminal 130, and the application server 140 of the system shown in FIG. 1. As shown in FIG. 6, the method may include the following operations.

Operation 610: The second terminal sends a registration request to the application server, and the application server receives the registration request sent by the second terminal, the registration request being configured for requesting to register the second terminal as a specified-type terminal.

The foregoing first terminal and the foregoing second terminal may be Web terminals, mobile terminals, desktop terminals, or embedded terminals. These terminals usually exist in a form of hardware, and communicate with the application server/another terminal to implement corresponding functions.

The foregoing specified-type terminal refers to a terminal that allows communication data with another terminal to be forwarded without passing through the application server. In other words, when the specified-type terminal sends a data packet to the another terminal, the data packet may not pass through the application server, but is forwarded to the another terminal by a core network device. In addition, when the another terminal sends a data packet to the foregoing specified-type terminal, the data packet may either not pass through the application server, but is forwarded to the specified-type terminal by the core network device.

The core network device stores an address of the second terminal as an address of the specified-type terminal in response to registration of the second terminal with the application server as the specified-type terminal.

In this embodiment of this application, the core network device stores the address of the second terminal as the address of the specified-type terminal. Because terminals of different types have different functions and requirements, by storing the address of the specified-type terminal, the core network device may perform targeted processing based on a terminal type. In addition, because the core network device stores an address of a terminal, during information transmission, provided that a destination address is consistent with the address stored in the core network device, the core network device can directly send, to the second terminal through a downlink channel, a data packet sent from the first terminal to the second terminal, thereby greatly improving information transmission efficiency.

For a process in which the core network device stores the address of the second terminal as the address of the specified-type terminal, refer to operation 620 and operation 630.

Operation 620: The application server sends an address addition request to the core network device, and the core network device receives the address addition request, the address addition request including an address of the second terminal.

In other words, the address addition request is sent by the application server after the application server receives the registration request sent by the second terminal.

In some embodiments, the application server may extract an IP address of the second terminal from the registration request sent by the second terminal, to store the IP address of the second terminal as the address of the specified-type terminal.

In some embodiments, the application server may extract the IP address of the second terminal from the registration request sent by the second terminal, query an address parsing protocol table by using the IP address, to obtain a MAC address of the second terminal, and store the MAC address of the second terminal as the address of the specified-type terminal.

In this embodiment of this application, after accessing a network, the second terminal establishes an uplink channel and a downlink channel with the core network device, and then initiates a registration request to the application server, to request to be registered as the specified-type terminal, so that the data packet subsequently sent to the second terminal can be directly forwarded by the core network device without passing through the application server. After the application server receives the registration request sent by the second terminal and registers the second terminal as the specified-type terminal, in order to enable the core network device to accurately forward the data packet of the second terminal subsequently, the application server may send the address addition request to the core network device, to notify the core network device of the address of the second terminal that is registered as the specified-type terminal.

In this embodiment of this application, the application server may send the foregoing address addition request to a user plane in the core network device.

In a possible implementation, the application server may alternatively store terminal information of the second terminal as terminal information of the specified-type terminal, the terminal information including a terminal identifier and an address.

For example, the application server may maintain a terminal information table. The terminal information table includes terminal identifiers of all specified-type terminals and addresses corresponding to the terminal identifiers.

Operation 630: The core network device stores the address of the second terminal as an address of the specified-type terminal based on the address addition request.

In this embodiment of this application, after receiving the address addition request, the core network device may store the address carried in the address addition request as the address of the specified-type terminal.

In a possible implementation, an address table (form) may be set in the core network device, and the address table stores addresses of all specified-type terminals.

For example, the core network device may store the foregoing address table on the user plane.

In one embodiment, the addresses of all the specified-type terminals may alternatively be stored in a format other than a table. For example, the addresses of all the specified-type terminals may alternatively be stored in a data set.

In addition to operation 620 and operation 630, the core network device may alternatively store the address of the second terminal as the address of the specified-type terminal in another manner.

For example, the core network device receives the registration request sent by the second terminal, extracts the address of the second terminal from the registration request while forwarding the registration request to the application server, and caches the address of the second terminal as the address of the specified-type terminal. Subsequently, the application server sends a registration success response to the core network device, the registration success response being configured for indicating that the second terminal has been successfully registered as the specified-type terminal. The core network device receives the registration success response, and forwards the registration success response to the second terminal. Meanwhile, the core network device parses the registration success response, and determines that the second terminal is successfully registered. For example, the registration success response includes registration success indication information. The core network device determines, based on the registration success indication information, that the received response sent by the application server is a registration success response, and determines, based on a destination IP address in a packet header of a data packet of the registration success response, that the registration success response is a response sent to the second terminal, that is, determines that the second terminal is successfully registered. In this case, the core network device formally stores the pre-cached address of the specified-type terminal as the address of the specified-type terminal. In the foregoing solution, before receiving the registration success response, the core network device may prepare an address to be stored, and subsequently, when receiving the registration success response, the core network device may store the prepared address. Compared with the solutions shown in operation 620 and operation 630, the address to be stored may be prepared in advance, thereby shortening duration for the core network device to complete storing the address of the specified-type terminal; and the application server does not need to additionally send the address addition request to the core network device, thereby saving signaling resources between the application server and the core network device.

The core network device may extract the IP address of the second terminal from the registration request sent by the second terminal, to cache the IP address of the second terminal as the address of the specified-type terminal.

In some embodiments, the core network device may extract the IP address of the second terminal from the registration request sent by the second terminal, query the address parsing protocol table by using the IP address, to obtain the MAC address of the second terminal, and cache the MAC address of the second terminal as the address of the specified-type terminal.

In a possible implementation, the method further includes:
querying, in response to that the downlink channel between the core network device and the second terminal is disconnected, the address of the specified-type terminal stored in the core network device for the address of the second terminal;
removing, by the core network device, the found address of the second terminal from the address of the specified-type terminal stored in the core network device; and
sending, by the core network device, an offline notification to the application server, the offline notification being configured for indicating that the second terminal is offline.

Correspondingly, the application server may receive the offline notification sent by the core network device, and the offline notification is configured for indicating that the second terminal is offline. The application server may delete the address of the second terminal from stored terminal information of all specified-type terminals.

After receiving the offline notification sent by the core network device, the application server first determines an identifier, for example, an IP address or a MAC address, of the address of the second terminal, then finds a data structure storing terminal information, for example, a hash table or a database structure, then traverses the data structure storing the terminal information, and determines, through comparison, whether an identifier of each terminal address matches the identifier of the terminal address to be deleted. Finally, the application server performs a deletion operation on the address of the second terminal based on the data structure. For example, when the data structure is the hash table, the application server may remove a key-value pair corresponding to the address of the second terminal from the hash table. For another example, when the data structure is the database structure, the application server may delete a record corresponding to the second terminal from the database structure.

In this embodiment of this application, the address of the second terminal that has been offline is deleted, so that invalid sending of data can be avoided, a data internal memory is cleared, delay of data transmission is reduced, and efficiency of the data transmission is improved.

In this embodiment of this application, when the downlink channel between the second terminal and the core network device is disconnected, the core network device may determine that the second terminal is offline. In this case, the core network device may notify the application server of an offline state of the second terminal, so that the application server can instantly delete the address of the second terminal from the terminal information of all the specified-type terminals stored in the application server, and another terminal can find, from the application server, that the second terminal is offline, thereby avoiding invalid sending of data.

In another possible implementation, in response to that the downlink channel between the core network device and the second terminal is disconnected, when finding the address (for example, the MAC address) of the second terminal from the stored address of the specified-type terminal, the core network device may not remove the address of the second terminal, but mark the address of the second terminal as being offline. Correspondingly, the application server may not delete the address of the second terminal, but mark the address of the second terminal as being offline. Subsequently, when the second terminal is online again, for example, when the second terminal establishes the downlink channel to the core network device again, the core network device may mark the address of the second terminal as being online, and send an online notification to the application server. After receiving the online notification, the application server marks the address of the second terminal as being online. In this way, the second terminal does not need to be registered each time the second terminal is online, thereby saving a signaling resource, a processing resource, and processing time of terminal registration.

In the solution shown in this embodiment of this application, that the second terminal is registered as the specified-type terminal is merely used as an example to describe an interaction procedure between the terminal, the core network device, and the application server in a registration process of the specified-type terminal. In one embodiment, any terminal may be registered as the specified-type terminal based on the foregoing solution, and when the terminal is offline, the core network device and the application server are triggered to delete an address of the terminal, or when the foregoing address is a MAC address, the core network device and the application server are triggered to mark an online/offline state of the address.

Operation 640: The first terminal obtains the address of the second terminal.

In a possible implementation, when obtaining the address of the second terminal, the first terminal may perform the following operations:
The first terminal sends an address query request to the application server, the address query request being configured for querying the address of the specified-type terminal;
the first terminal receives terminal information of all specified-type terminals returned by the application server, the terminal information including a terminal identifier and an address; and
the first terminal obtains the address of the second terminal from the terminal information of all the specified-type terminals.

The foregoing terminal identifier may be a registered account of a terminal, a device name of a terminal, or the like.

Correspondingly, the application server may receive the address query request sent by the first terminal, the address query request being configured for querying the address of the specified-type terminal.

The application server may further send the terminal information of all the specified-type terminals stored in the application server to the first terminal, so that the first terminal obtains the address of the second terminal from the terminal information of all the specified-type terminals. In this embodiment of this application, the first terminal may query the application server for the addresses of all the specified-type terminals, to send data to a specific terminal. In this case, the first terminal may send the address query request to the application server, and the application server may send terminal information of all registered specified-type terminals to the first terminal. The first terminal determines, based on terminal identifiers in the terminal information of all the registered specified-type terminals, a terminal to be found, and obtains an address of the terminal to be found, for subsequent use during data packet sending.

Operation 650: The first terminal generates a data packet by using the address of the second terminal as a destination address.

In this embodiment of this application, when needing to send data to the second terminal, the first terminal may generate, based on a specified data transmission protocol, a data packet of which a destination address is the address of the second terminal, a source address of the data packet being an address of the first terminal.

Operation 660: The first terminal sends the data packet to the core network device, and the core network device receives the data packet sent by the first terminal.

In this embodiment of this application, the first terminal may send the data packet to the core network device through an uplink channel to the core network device.

For example, the first terminal may send the data packet to the user plane of the core network device through the uplink channel to the core network device, so that the user plane of the core network device performs subsequent forwarding based on the destination address of the data packet.

Operation 670: The core network device obtains the destination address of the data packet.

In this embodiment of this application, the core network device may parse a packet header of the data packet, and extract the destination address of the data packet from a destination address field in the packet header.

Operation 680: The core network device sends, in response to that the destination address is the address of the specified-type terminal stored in the core network device, the data packet to the second terminal through a downlink channel between the core network device and the second terminal corresponding to the destination address, and the second terminal receives the data packet.

In a possible implementation, the core network device may query an address table stored on the user plane of the core network device for the destination address, the address table storing an address of one or more specified-type terminals.

If the destination address is found in the address table, the core network device may send the data packet to the second terminal on the user plane of the core network device through the downlink channel between the core network device and the second terminal.

In this embodiment of this application, the core network device receives the data packet sent by the first terminal device, the data packet including the destination address. The user plane of the core network device compares the destination address with a prefix of each entry in the address table, to determine whether matching succeeds. If the matching succeeds, the core network device may directly send the data packet to the second terminal through the downlink channel between the core network device and the second terminal corresponding to the destination address, thereby improving transmission efficiency.

In one embodiment, if the destination address is not found in the address table, the core network device may determine that the data packet is not a data packet sent to the specified-type terminal. In this case, the core network device may forward the data packet to the application server, and the application server performs subsequent forwarding or processing.

In a possible implementation, the core network device may further obtain the address of the first terminal; and
if the address of the first terminal and the destination address are both addresses of specified-type terminals stored in the core network device, the core network device sends the data packet to the second terminal through the downlink channel between the core network device and the second terminal.

In the solution shown in this embodiment of this application, when both a sending end and a receiving end of the data packet are the specified-type terminals, the core network device may directly send the data packet to the second terminal, thereby limiting data sent to the second terminal, and ensuring security of receiving data by the second terminal.

In an embodiment, the solution shown in the foregoing embodiment of this application may be applied to low-delay transmission of data between terminals.

From a product side, the solution in the foregoing embodiment of this application may be applied to a 5G network product and a 5G industrial Internet application. For the 5G network product, a function of direct forwarding IP data of a 5G terminal is developed in a user plane device UPF of a 5G core network. When a 5G terminal-A sends uplink data to a 5G terminal-B, the data reaches the UPF through a base station, and the UPF may directly forward the data to the 5G terminal-B through a downlink channel, and vice versa. In addition, an embodiment of this application implements a lightweight application server for an industrial Internet application, and provides a 5G terminal registration and query service. In an industrial Internet scenario, communication between 5G terminals usually uses a device ID, and the service stores all online device IDs and IP addresses. The 5G terminal may query all the online device IDs and IP addresses regularly, to initiate a data interaction request in time. In addition, an embodiment of this application further implements a device registration and query APP module for the industrial Internet application. The module implements a function of actively obtaining an ID and an IP address of a terminal after the terminal is online, and updates the ID and the IP address through a regular query mechanism.

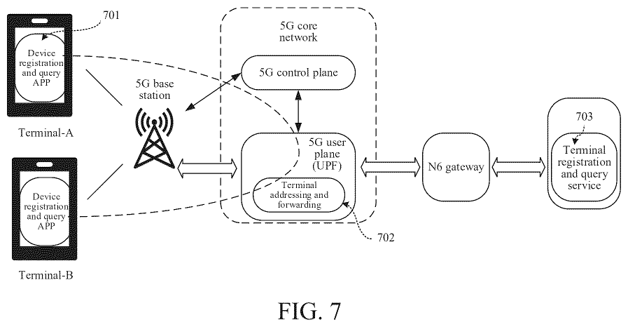

From a technical side, a system hardware framework in this embodiment includes 5G terminals, a 5G base station (5G NR), a 5G core network, an N6 gateway, and an application server that provides the terminal registration and query service. Refer to FIG. 7. FIG. 7 is a schematic structural diagram of a network according to this application. An industrial Internet device registration and query APP 701 is deployed on the 5G terminal, a developed terminal addressing and forwarding module 702 is integrated into a user plane device UPF of a 5G core network, and a lightweight terminal registration and query service module 703 is deployed on an application server side.

A technical detailed implementation solution of this embodiment is shown in FIG. 7. In this embodiment, in an existing private 5G network product and industrial Internet solution, the three software modules are developed to accelerate data interaction between the 5G terminals. Functions of the three software modules are described below.
1. Device registration and query APP 701. The device registration and query APP 701 is deployed on the 5G industrial terminal. When the 5G industrial terminal is online, the device registration and query APP 701 sends a registration request to the terminal registration and query service on a core network side, the registration request including a device ID and an IP address of the device. In addition, the device registration and query APP 701 internally stores device IDs of all other industrial Internet terminals requiring communication. After completing registering in the terminal registration and query service on the core network side, the terminal may send a terminal device query request to the terminal registration and query service on the core network side, the request carrying IDs of all locally stored industrial Internet devices, and then the terminal receives a response. If a device ID1 for which an IP address is null is found in the response, a request is repeatedly sent every one second. Once the IP address for the corresponding device ID1 is obtained, a 16 s timed query is started, to refresh a status of each device ID regularly.
2. Terminal addressing and forwarding module 702. The module is integrated into the user plane device UPF of the 5G core network. First, the module detects whether a destination address of an IP packet sent by the 5G terminal-A is another registered 5G terminal. If not, the IP packet is forwarded to a data network through an N6 interface; otherwise, the IP packet is directly forwarded to the corresponding 5G terminal. In addition, after being offline, the 5G terminal needs to send an offline notification to the terminal registration and query service, and the service sets an IP address corresponding to an ID of the device to null.
3. Terminal registration and query service module 703. The terminal registration and query service module is deployed on the application server side, and is used as a lightweight application server. After the 5G terminal is online, the device ID and the IP address of the 5G terminal are registered in a conventional manner. The terminal registration and query service module 703 stores IDs and IP addresses of all devices, and receives queries of all 5G terminals. After a query request sent by a 5G terminal is received, the IDs and IP addresses of all industrial devices are returned to the terminal. If a terminal is not online, a corresponding IP address is null. In addition, after a terminal is offline, the UPF sends a notification to the terminal registration and query service module 703, and the terminal registration and query service module 703 sets an IP address corresponding to an ID of the terminal device to null.

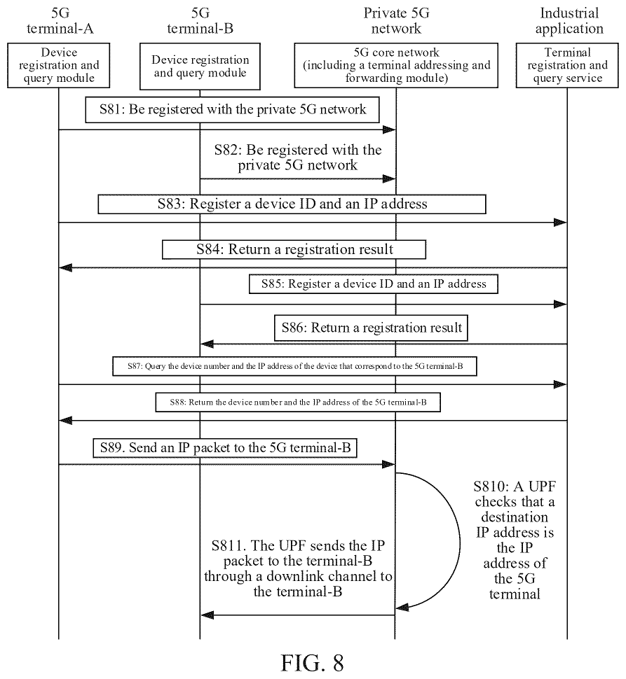

Based on the architecture shown in FIG. 7, an end-to-end service procedure in this embodiment is described in detail below. To describe the procedure more clearly, an example in which a network includes two 5G terminals is used, and a data interaction procedure between the two 5G terminals is described in detail. Refer to FIG. 8. FIG. 8 is a schematic diagram of an end-to-end service procedure according to this application. As shown in FIG. 8, a specific implementation process is described as follows.
S81: After being turned on, a 5G terminal-A is registered with a private 5G network. The registration of the 5G terminal with the private 5G network herein may be a process in which the 5G terminal accesses the private 5G network through a communication protocol of a 5G network.
S82: After being turned on, a 5G terminal-B is registered with the private 5G network.
S83: A device registration and query module (namely, the foregoing device registration and query APP 701) on the 5G terminal-A initiates a request to a terminal registration and query service (namely, the foregoing terminal registration and query service module 703) through the private 5G network, to register a device ID and an IP address of the 5G terminal-A.
S84: The terminal registration and query service returns a registration result to the 5G terminal-A.
S85: A device registration and query module (namely, the foregoing device registration and query APP 701) on the 5G terminal-B initiates a request to the terminal registration and query service through the private 5G network, to register a device ID and an IP address of the 5G terminal-B.
S86: The terminal registration and query service returns a registration result to the 5G terminal-B.
S87: The device registration and query module on the 5G terminal-A initiates a request to the terminal registration and query service through the private 5G network, to request to query the device number and the IP address of the device that correspond to the 5G terminal-B.
S88: The terminal registration and query service returns the device number and the IP address of the 5G terminal-B.
S89. The 5G terminal-A starts to send an IP packet to the 5G terminal-B, and the packet is sent to a user plane device UPF of a 5G core network.
S810: The UPF checks that a destination IP address is the IP address of the 5G terminal, and then delivers the IP packet to a terminal addressing and forwarding module (namely, the foregoing terminal addressing and forwarding module 702) for processing.
S811: The UPF directly sends the IP packet to the 5G terminal-B through a downlink channel between the UPF and the 5G terminal-B.

A backhaul IP data packet returns along an original path, and details are not described herein again.

The technical solutions provided in this embodiment may include the following beneficial effects:
1. By enhancing a function of the user plane device UPF of the 5G core network and with cooperation of a lightweight application server, data interaction between 5G terminals can be completed inside the user plane device UPF of the 5G core network, thereby shortening a transmission path for data interaction between the 5G terminals, and further reducing a delay.
2. This embodiment also greatly reduces network bandwidth between the UPF and the application server, and data packet exchange between the terminals no longer needs to be performed from the UPF to the application server, thereby also reducing network bandwidth occupation between the UPF and the application server.
3. As a data transmission path during data exchange between terminals is shortened, network quality, network security, and reliability of an industrial Internet application in a private 5G network environment are greatly improved.

Certainly, the application server installed with the terminal registration and query service in this embodiment is deployed in a data network behind an N6 gateway, or certainly may alternatively be deployed on an edge computing device, and is directly connected to the 5G user plane device UPF for deployment. In addition, in this embodiment, to improve real-time performance of data access between the terminals, after a terminal is online, locally stored device numbers and IP addresses of all terminals are requested one time. If a requirement on the real-time performance is not high, a dynamic and independent obtaining manner may alternatively be used. For example, when a terminal needs to be accessed, a query request is initiated to the application server having the terminal registration and query service.

Main innovation of this embodiment includes: In an industrial Internet application scenario of the private 5G network, for a case in which a quantity of terminals is small, a network structure is simple, and a large amount of data is exchanged between the terminals, a method for implementing efficient data exchange between 5G terminals in the private 5G network environment is provided. First, after the 5G terminal is turned on, a device registration and query APP deployed on the terminal actively reports a device name and an IP address to a device registration and query service in a core network, and then, the 5G terminal obtains device names and IP addresses of all online terminals from the application server. Correspondingly, the 5G terminal may perform terminal query based on the obtained device names and IP addresses of all the online 5G terminals. Then, when the terminal-A needs to communicate with the terminal-B, the terminal-A finds the IP address of the terminal-B from an obtained terminal information list, and directly sends the IP packet to the terminal-B. Finally, in this embodiment, the terminal addressing and forwarding module is integrated into the user plane device UPF of the 5G core network, so that the UPF directly sends, to the terminal-B through the downlink channel, the IP packet sent by the terminal-A to the terminal-B in an uplink. This implementation method shortens a data transmission path between the terminal-A and the terminal-B, and further reduces a delay. In addition, because exchange of the data packet between the terminals is performed on the UPF, network bandwidth between the UPF and the application server is greatly reduced, and reliability of data interaction between the terminals is also improved.

FIG. 9 is a block diagram of a data transmission apparatus according to an exemplary embodiment of this application. The apparatus may be configured to perform all or some operations performed by the core network device in the method shown in any one of FIG. 3 to FIG. 6. The apparatus includes:
a receiving module 901, configured to receive a data packet sent by a first terminal;
an address obtaining module 902, configured to obtain a destination address of the data packet; and
a sending module 903, configured to send, if the destination address is an address of a specified-type terminal stored in the core network device, the data packet to a second terminal through a downlink channel between the core network device and the second terminal corresponding to the destination address.

In some embodiments, the apparatus further includes:
a first query module, configured to query an address table stored on a user plane of the core network device for the destination address, the address table storing an address of one or more specified-type terminals; and
the sending module 903, further configured to send, if the destination address is found in the address table, the data packet to the second terminal on the user plane of the core network device through the downlink channel between the core network device and the second terminal.

In some embodiments, the apparatus further includes:
a storing module, configured to store an address of the second terminal as the address of the specified-type terminal in response to registration of the second terminal with an application server as the specified-type terminal.

In some embodiments, the receiving module 901 is further configured to receive an address addition request sent by the application server, the address addition request including the address of the second terminal, the address addition request being sent by the application server after the application server receives a registration request sent by the second terminal, and the registration request being configured for requesting to register the second terminal as the specified-type terminal.

In this case, the storing module is specifically configured to:
store the address of the second terminal as the address of the specified-type terminal based on the address addition request.

In some embodiments, the apparatus further includes:
a second querying module, configured to query, in response to that the downlink channel between the core network device and the second terminal is disconnected, the address of the specified-type terminal stored in the core network device for the address of the second terminal;
a removing module, configured to remove the found address of the second terminal from the address of the specified-type terminal stored in the core network device; and
the sending module 903, further configured to send an offline notification to the application server, the offline notification being configured for indicating that the second terminal is offline.

In some embodiments, the apparatus further includes:
an address obtaining module 902, configured to obtain an address of the first terminal; and
the sending module 903, further configured to send, if the address of the first terminal and the destination address are both addresses of specified-type terminals stored in the core network device, the data packet to the second terminal through the downlink channel between the core network device and the second terminal.

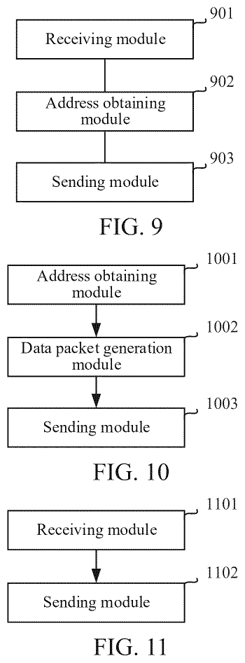

FIG. 10 is a block diagram of a data transmission apparatus according to an exemplary embodiment of this application. The apparatus may be configured to perform all or some operations performed by the first terminal in the method shown in any one of FIG. 3 to FIG. 6. The apparatus includes:
an address obtaining module 1001, configured to obtain an address of a second terminal;
a data packet generation module 1002, configured to generate a data packet by using the address of the second terminal as a destination address; and
a sending module 1003, configured to: send the data packet to a core network device, so that the core network device obtains the destination address of the data packet, and send the data packet to the second terminal through a downlink channel between the core network device and the second terminal when the destination address is an address of a specified-type terminal stored in the core network device.

In some embodiments, the address obtaining module 1001 includes:
a query sub-module, configured to send an address query request to an application server, the address query request being configured for querying the address of the specified-type terminal;
a receiving sub-module, configured to receive terminal information of all specified-type terminals returned by the application server, the terminal information including a terminal identifier and an address; and
an address obtaining sub-module, configured to obtain the address of the second terminal from the terminal information of all the specified-type terminals.

FIG. 11 is a block diagram of a data transmission apparatus according to an exemplary embodiment of this application. The apparatus may be configured to perform all or some operations performed by the application server in the method shown in any one of FIG. 3 to FIG. 6. The apparatus includes:
a receiving module 1101, configured to receive a registration request sent by a second terminal; the registration request being configured for requesting to register the second terminal as a specified-type terminal; and
a sending module 1102, configured to send an address addition request to a core network device, the address addition request including an address of the second terminal, and the address addition request being configured for indicating the core network device to store the address of the second terminal as an address of the specified-type terminal, so that after the core network device receives a data packet sent by a first terminal and obtains a destination address of the data packet, the core network device sends, when the destination address is the address of the specified-type terminal stored in the core network device, the data packet to the second terminal through a downlink channel between the core network device and the second terminal corresponding to the destination address.

In some embodiments, the apparatus further includes:
a terminal information storage module, configured to store terminal information of the second terminal as terminal information of the specified-type terminal, the terminal information including a terminal identifier and an address;
the receiving module 1101, further configured to receive an address query request sent by the first terminal, the address query request being configured for querying an address of a specified-type terminal; and
the sending module 1102, further configured to send terminal information of all specified-type terminals stored in the application server to the first terminal, so that the first terminal obtains the address of the second terminal from the terminal information of all the specified-type terminals.

In some embodiments, the receiving module 1101 is further configured to receive an offline notification sent by the core network device, the offline notification being configured for indicating that the second terminal is offline.

The apparatus further includes:
a deletion module, configured to delete the address of the second terminal from the stored terminal information of all the specified-type terminals.

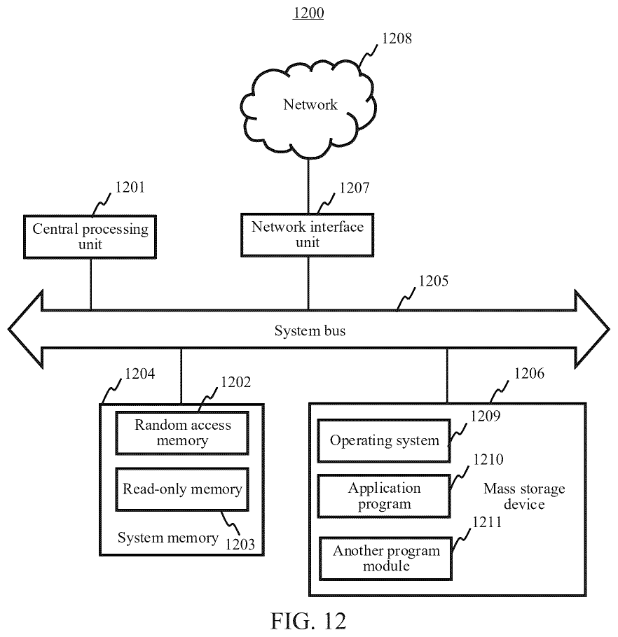

FIG. 12 is a structural block diagram of a computer device 1200 according to an exemplary embodiment of this application. The computer device may be implemented as the server in the foregoing solutions of this application. The computer device 1200 includes a central processing unit (CPU) 1201, a system memory 1204 including a random access memory (RAM) 1202 and a read-only memory (ROM) 1203, and a system bus 1205 connecting the system memory 1204 and the central processing unit 1201. The computer device 1200 further includes a mass storage device 1206 configured to store an operating system 1209, an application 1210, and another program module 1211.

The mass storage device 1206 is connected to the central processing unit 1201 via a mass storage controller (not shown) connected to the system bus 1205. The mass storage device 1206 and an associated computer-readable medium provide non-volatile storage for the computer device 1200. In other words, the mass storage device 1206 may include a computer-readable medium (not shown), for example, a hard disk or a compact disc read-only memory (CD-ROM) drive.

Generally, the computer-readable medium may include a computer storage medium and a communication medium. The computer storage medium includes volatile and non-volatile, removable and non-removable media implemented by using any method or technology for storing information such as computer-readable instructions, a data structure, a program module, or other data. The computer storage medium includes a RAM, a ROM, an erasable programmable read-only memory (EPROM), an electrically erasable programmable read-only memory (EEPROM), a flash memory or another solid-state storage technology, a CD-ROM, a digital versatile disc (DVD) or another optical storage, a magnetic tape cartridge, a magnetic tape, a magnetic disk storage, or another magnetic storage device. Certainly, a person skilled in art may know that the computer storage medium is not limited to the foregoing several types. The foregoing system memory 1204 and the foregoing mass storage device 1206 may be collectively referred to as a memory.

According to various embodiments of this disclosure, the computer device 1200 may further be connected, through a network like the Internet, to a remote computer on the network and run. In other words, the computer device 1200 may be connected to a network 1208 via a network interface unit 1207 connected to the system bus 1205, or may be connected to another type of network or a remote computer system (not shown) via a network interface unit 1207.

The memory further includes at least one computer program. The at least one computer program is stored in the memory. The central processing unit 1201 implements all or some operations of the methods in the foregoing embodiments by executing the at least one computer program.

An exemplary embodiment of this application further provides a non-transitory computer-readable storage medium, configured to store at least one computer program. The at least one computer program is loaded and executed by a processor to implement all or some operations of the methods in the foregoing embodiments. For example, the computer-readable storage medium may be a read-only memory (ROM), a random access memory (RAM), a compact disc read-only memory (CD-ROM), a magnetic tape, a floppy disk, or an optical data storage device.

An exemplary embodiment further provides a computer program product or a computer program. The computer program product or the computer program includes computer instructions. The computer instructions are stored in a non-transitory computer-readable storage medium. A processor of a computer device reads the computer instructions from the computer-readable storage medium, and the processor executes the computer instructions, so that the computer device performs all or some operations of the methods in the foregoing embodiments.

After considering the specification and practicing this disclosure, a person skilled in the art may easily conceive of other implementations of this application. This application is intended to cover any variations, uses, or adaptive changes of this application. These variations, uses, or adaptive changes follow the general principles of this application and include common general knowledge or common technical means in the art which are not disclosed in this application. The specification and embodiments are considered as merely exemplary, and the real scope and spirit of this application are pointed out in the following claims.

This application is not limited to the precise structures described above and shown in the accompanying drawings, and various modifications and changes can be made without departing from the scope of this application.

What is claimed is:

1. A data transmission method, performed by a computer device acting as a core network device of a network including a first terminal and a second terminal, the method comprising:
receiving a data packet sent by the first terminal;
obtaining a destination address of the data packet; and
when the destination address is an address of a specified-type terminal stored in the core network device, sending the data packet to the second terminal through a downlink channel between the core network device and the second terminal corresponding to the destination address.

2. The method according to claim 1, wherein the sending the data packet to the second terminal through a downlink channel between the core network device and the second terminal corresponding to the destination address comprises:
querying an address table stored on a user plane of the core network device for the destination address, the address table storing an address of one or more specified-type terminals; and
when the destination address is found in the address table, sending the data packet to the second terminal on the user plane of the core network device through the downlink channel between the core network device and the second terminal.

3. The method according to claim 1, wherein before the sending the data packet to the second terminal through a downlink channel between the core network device and the second terminal corresponding to the destination address, the method further comprises:
storing an address of the second terminal as the address of the specified-type terminal in response to registration of the second terminal with an application server as the specified-type terminal.

4. The method according to claim 3, wherein the storing an address of the second terminal as the address of the specified-type terminal in response to registration of the second terminal with an application server as the specified-type terminal comprises:
receiving an address addition request sent by the application server, the address addition request comprising the address of the second terminal, the address addition request being sent by the application server after the application server receives a registration request sent by the second terminal, and the registration request being configured for requesting to register the second terminal as the specified-type terminal; and
storing the address of the second terminal as the address of the specified-type terminal based on the address addition request.

5. The method according to claim 1, wherein the method further comprises:
querying, in response to that the downlink channel between the core network device and the second terminal is disconnected, the address of the specified-type terminal stored in the core network device for the address of the second terminal;
removing the found address of the second terminal from the address of the specified-type terminal stored in the core network device; and
sending an offline notification to an application server, the offline notification being configured for indicating that the second terminal is offline.

6. The method according to claim 1, wherein before the sending the data packet to the second terminal through a downlink channel between the core network device and the second terminal corresponding to the destination address, the method further comprises:
obtaining an address of the first terminal; and
when the address of the first terminal and the destination address are both addresses of specified-type terminals stored in the core network device, sending the data packet to the second terminal through the downlink channel between the core network device and the second terminal.

7. A computer device, the computer device comprising a processor, a memory, and a transceiver, the memory having at least one computer program stored therein, and the at least one computer program being loaded and executed by the processor, causing the computer device to act as a core network device of a network including a first terminal and a second terminal and implement a data transmission method including:
receiving a data packet sent by the first terminal;
obtaining a destination address of the data packet; and
when the destination address is an address of a specified-type terminal stored in the core network device, sending the data packet to the second terminal through a downlink channel between the core network device and the second terminal corresponding to the destination address.

8. The computer device according to claim 7, wherein the sending the data packet to the second terminal through a downlink channel between the core network device and the second terminal corresponding to the destination address comprises:
querying an address table stored on a user plane of the core network device for the destination address, the address table storing an address of one or more specified-type terminals; and
when the destination address is found in the address table, sending the data packet to the second terminal on the user plane of the core network device through the downlink channel between the core network device and the second terminal.

9. The computer device according to claim 7, wherein before the sending the data packet to the second terminal through a downlink channel between the core network device and the second terminal corresponding to the destination address, the method further comprises:
storing an address of the second terminal as the address of the specified-type terminal in response to registration of the second terminal with an application server as the specified-type terminal.

10. The computer device according to claim 9, wherein the storing an address of the second terminal as the address of the specified-type terminal in response to registration of the second terminal with an application server as the specified-type terminal comprises:
receiving an address addition request sent by the application server, the address addition request comprising the address of the second terminal, the address addition request being sent by the application server after the application server receives a registration request sent by the second terminal, and the registration request being configured for requesting to register the second terminal as the specified-type terminal; and
storing the address of the second terminal as the address of the specified-type terminal based on the address addition request.

11. The computer device according to claim 7, wherein the method further comprises:
querying, in response to that the downlink channel between the core network device and the second terminal is disconnected, the address of the specified-type terminal stored in the core network device for the address of the second terminal;
removing the found address of the second terminal from the address of the specified-type terminal stored in the core network device; and
sending an offline notification to an application server, the offline notification being configured for indicating that the second terminal is offline.

12. The computer device according to claim 7, wherein before the sending the data packet to the second terminal through a downlink channel between the core network device and the second terminal corresponding to the destination address, the method further comprises:
obtaining an address of the first terminal; and
when the address of the first terminal and the destination address are both addresses of specified-type terminals stored in the core network device, sending the data packet to the second terminal through the downlink channel between the core network device and the second terminal.

13. A non-transitory computer-readable storage medium, having at least one computer program stored therein, and the computer program, when being loaded and executed by a processor of a computer device, causing the computer device to act as a core network device of a network including a first terminal and a second terminal and implement a data transmission method including:
receiving a data packet sent by the first terminal;
obtaining a destination address of the data packet; and
when the destination address is an address of a specified-type terminal stored in the core network device, sending the data packet to the second terminal through a downlink channel between the core network device and the second terminal corresponding to the destination address.

14. The non-transitory computer-readable storage medium according to claim 13, wherein the sending the data packet to the second terminal through a downlink channel between the core network device and the second terminal corresponding to the destination address comprises:
querying an address table stored on a user plane of the core network device for the destination address, the address table storing an address of one or more specified-type terminals; and
when the destination address is found in the address table, sending the data packet to the second terminal on the user plane of the core network device through the downlink channel between the core network device and the second terminal.

15. The non-transitory computer-readable storage medium according to claim 13, wherein before the sending the data packet to the second terminal through a downlink channel between the core network device and the second terminal corresponding to the destination address, the method further comprises:
storing an address of the second terminal as the address of the specified-type terminal in response to registration of the second terminal with an application server as the specified-type terminal.

16. The non-transitory computer-readable storage medium according to claim 15, wherein the storing an address of the second terminal as the address of the specified-type terminal in response to registration of the second terminal with an application server as the specified-type terminal comprises:
receiving an address addition request sent by the application server, the address addition request comprising the address of the second terminal, the address addition request being sent by the application server after the application server receives a registration request sent by the second terminal, and the registration request being configured for requesting to register the second terminal as the specified-type terminal; and
storing the address of the second terminal as the address of the specified-type terminal based on the address addition request.

17. The non-transitory computer-readable storage medium according to claim 13, wherein the method further comprises:
querying, in response to that the downlink channel between the core network device and the second terminal is disconnected, the address of the specified-type terminal stored in the core network device for the address of the second terminal;
removing the found address of the second terminal from the address of the specified-type terminal stored in the core network device; and
sending an offline notification to the application server, the offline notification being configured for indicating that the second terminal is offline.

18. The non-transitory computer-readable storage medium according to claim 13, wherein before the sending the data packet to the second terminal through a downlink channel between the core network device and the second terminal corresponding to the destination address, the method further comprises:
obtaining an address of the first terminal; and
when the address of the first terminal and the destination address are both addresses of specified-type terminals stored in the core network device, sending the data packet to the second terminal through the downlink channel between the core network device and the second terminal.
